(19) United States
(12) Patent Application Publication
(10) Pub. No.: US 2022/0024701 A1
(43) Pub. Date: Jan. 27, 2022

(54) CONTINUOUS PROCESSING OF PRODUCTS WITH AUTONOMOUS TROLLEY CONVEYANCE

(71) Applicant: SIDEL ENGINEERING & CONVEYING SOLUTIONS, Reichstett (FR)

(72) Inventors: Julien BERGER, Reichstett (FR); Anthony GEHIN, Reichstett (FR); Patrick HUTTER, Reichstett (FR)

(21) Appl. No.: 17/296,138

(22) PCT Filed: Nov. 21, 2019
(86) PCT No.: PCT/EP2019/082105

§ 371 Date: May 21, 2021

(51) Int. Cl. B65G 47/68; B65G 47/82

(52) U.S. Cl. CPC B65G 47/682; B65G 47/82

(57) ABSTRACT

The invention relates to a continuous processing line for products comprising a plurality of successive processing stations for said products and a plurality of autonomous self-supporting movable trolleys moving on the floor to transport the products from an upstream station to a downstream station. The upstream station also includes an exit transfer unit that is designed to absorb the continuous flow of products from the exit conveyor and to transfer said products in batches of one or more rows onto at least one receiving surface. The transfer unit includes a transit conveyor comprising at least two single-lane transit conveyors of different lengths, and a diverter designed to direct the flow of products alternately to one or other of the transit conveyors. The invention also relates to a method for transporting products from an upstream station to a downstream station on such a processing line for products.

The present invention relates to the domain of conveyance equipment used in industrial product processing lines and is intended for a continuous product processing line and a product transfer method on such a line.

In the domain of the invention, a product processing line usually comprises a set of successive stations that transform the product to ultimately form a palette with stacked layers containing the products, grouped in packs, boxes, bundles and the like. At the downstream end of the line, the full pallet is then readied for shipment and ultimately reaches a logistics center, notably an automated warehouse. The product processing lines covered by the invention therefore perform at least one secondary packaging function to prepare individual products for mass shipment. The line can also have upstream functions, such as preparation, creation, manufacture and storage of the product upstream of such secondary packaging for shipment.

A large number of successive identical products are therefore processed similarly at successive stations on the line. The line therefore processes the products continuously and identically at an overall throughput rate that determines the performance of the line.

This type of line is therefore necessarily provided with means for moving the products between the stations. Conventionally, said means are endless mechanical conveyor belts that can turn continuously and upon which the lower portion of the products rest to be conveyed between the two ends of the belt. Adapted accumulation solutions also enable a buffer to be created between successive stations.

A conveyance solution for a processing line with accumulation between two individual-product processing stations is for example proposed in EP1497208 and is based on a module for transforming a single-lane flow into a multi-lane flow, an accumulation module for such a multi-lane flow, then a transformation module to transform the multi-lane flow into a single-lane flow.

Other movement equipment based on static mechanical conveyors is also proposed, for example in EP2188199 or U.S. Pat. No. 6,206,174.

The use of such packaging lines has nonetheless changed, with the number of identical products getting smaller. The formats of the products processed are therefore liable to change increasingly frequently, and the changes and reconfigurations required on the line are then also increasingly frequent. Furthermore, changes of format may require not only new settings for the stations on the line, but also replacement of certain stations on the line with others that are compatible with the new product being processed. This reconfiguration of the equipment that makes up the line is also caused by the normal upgrading of the line to add new machines, replace others, etc.

It is therefore increasingly important to have a packaging line upstream of the full-pallet logistics installation that is as flexible as possible, able to adapt very quickly to new product formats, and easy to upgrade to new configurations.

For this purpose, EP3075685 discloses a solution in which the static mechanical conveyors that conventionally link successive stations of an industrial line for moving the products from one machine to the next are replaced by autonomous, free-route moveable trolleys. This solution enables the machines or processing stations to be static and positioned at different locations within the workshop, repositioned, added and removed without having to re-design the static mechanical conveyance solutions. Adding a processing station to the line may therefore only require reprogramming of the trolleys.

This document specifies that the continuous flow of products coming out of a machine, for example in a single lane, can be cut into sections to be transferred transversely onto a trolley, which is filled before being moved inside the factory to the next machine. However, this document does not provide a solution for such cutting and transferring in batches, although the products are outputted continuously from the machines.

There is therefore a need for a flexible solution that also enables the transfer of products to autonomous trolleys in batches of one or more rows without disturbing the continuous feed flow of products to be transferred. There is also a need for this solution to have several locations for a trolley at the exit of a given processing station to enable rows of products to continue to be transferred to a new trolley while a trolley full of products is oriented towards the next station and replaced by another trolley, which is in principle empty.

The invention is therefore intended to propose a flexible solution guaranteeing the continuous transfer of products from one machine to another.

To do so, the invention proposes arranging several transit conveyors of different lengths at the end of the single-lane conveyor at the exit of a station, arranged side by side in a transfer zone. This makes it possible to alternately feed the transit conveyors so that the product rows on each transit conveyor reach the transfer zone substantially simultaneously. The transit conveyors can then be stopped in the transfer zone to simultaneously and transversely transfer all of the products therein onto a receiving surface positioned on one or other of the sides of the transfer zone, while continuing to continuously feed the transit conveyors.

The invention therefore relates to a continuous product processing line comprising a plurality of successive processing stations for said products and a plurality of autonomous self-supporting moveable trolleys moving on the floor to transport the products from an upstream station to a downstream station, said upstream station having an exit conveyor at the exit thereof to feed the processed products in a continuous single-lane flow.

This line is characterized in that said upstream station also includes an exit transfer unit arranged downstream of the exit conveyor that is designed to absorb the continuous flow of products from the exit conveyor and to transfer said products in batches of one or more rows onto at least one receiving surface that is the upper surface of at least one trolley; said transfer unit including at least:

transit conveyance means comprising at least two single-lane transit conveyors of different lengths, said conveyors initially following different paths followed by parallel paths at least within a transfer zone such that at least one trolley can be positioned alongside each longitudinal edge of the transit conveyance means and the products on the entirety of the transit conveyors within the transfer zone can be transferred simultaneously and transversely by least one transfer tool onto a receiving surface regardless of the longitudinal edge of the transit conveyance means alongside which said surface is located;
diverting means designed to direct the flow of products from the exit conveyor alternately to one or other of the transit conveyors.

The invention also relates to a method for transporting products from an upstream station to a downstream station on a processing line as defined above, involving transferring the products in batches of one or more rows from the exit conveyor of the upstream station to a receiving surface, then moving said products to the downstream station using the movement of the at least one trolley, the upper surface of which is the receiving surface.

This method is characterized in that the transfer of a batch of products involves at least the following steps:

(i) directing the continuous flow of products from the exit conveyor alternately to each of the transit conveyors, starting with the longest transit conveyor before switching from the longest transit conveyor to the shortest transit conveyor;
(ii) stopping all of the transit conveyors in the transfer zone when said zone is filled with products, while continuing to feed the transit conveyors according to step (i);
(iii) simultaneously transferring all of the products in the transfer zone onto a receiving surface arranged alongside one or other of the longitudinal edges of the transit conveyance means, while continuing to feed the transit conveyors according to step (i).

The invention can be better understood from the description below, which is based on possible embodiments, given by way of non-limiting examples and illustrated with reference to the attached figures, in which:

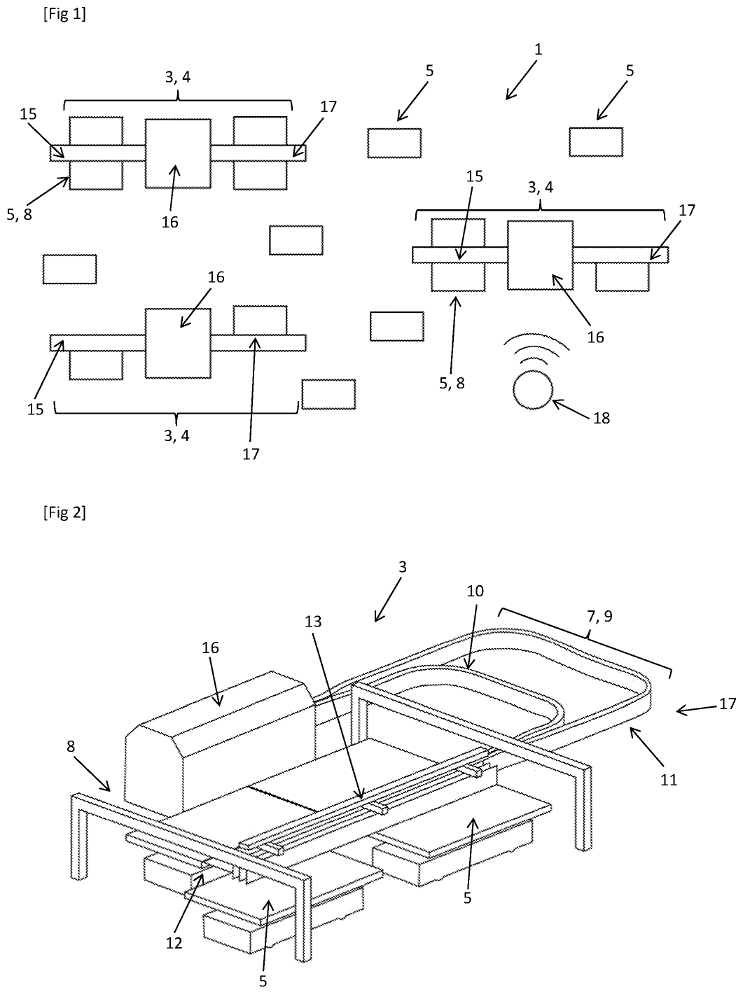

FIG. 1 is a schematic top view of a processing line according to one possible embodiment of the invention,

FIG. 2 is a perspective view of an upstream station, and more specifically of an exit zone of an upstream station according to one possible embodiment of the invention,

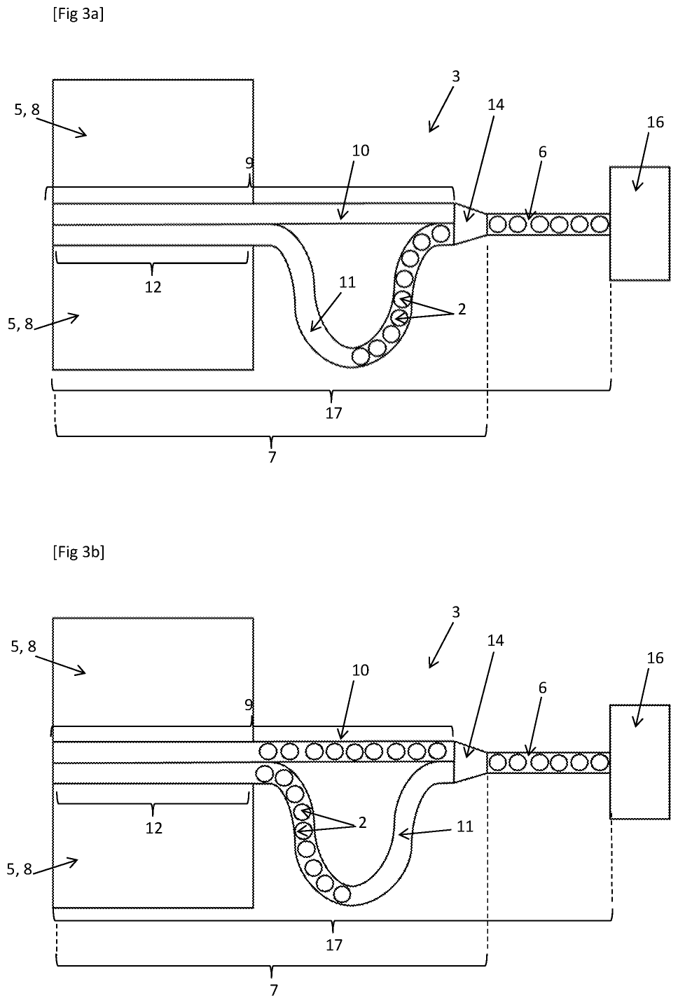

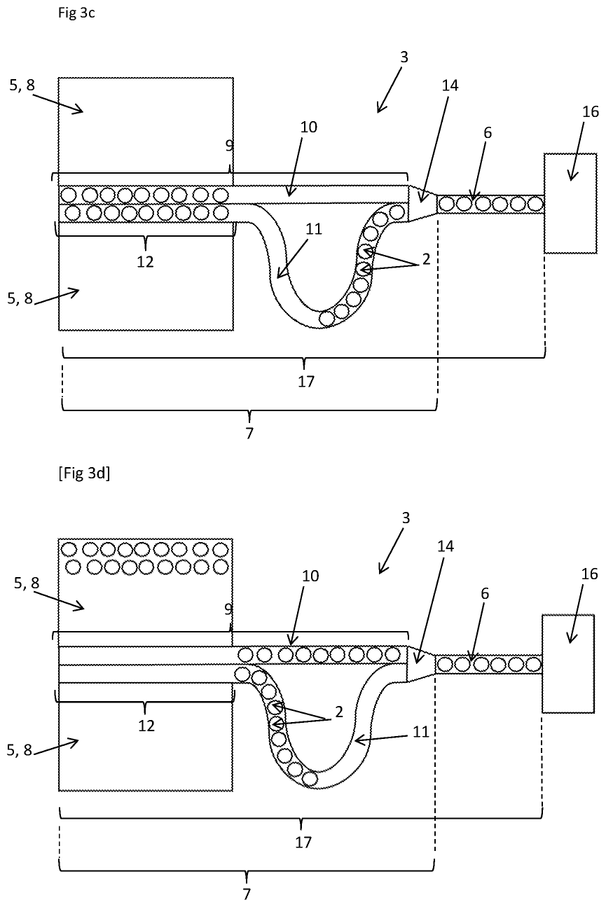

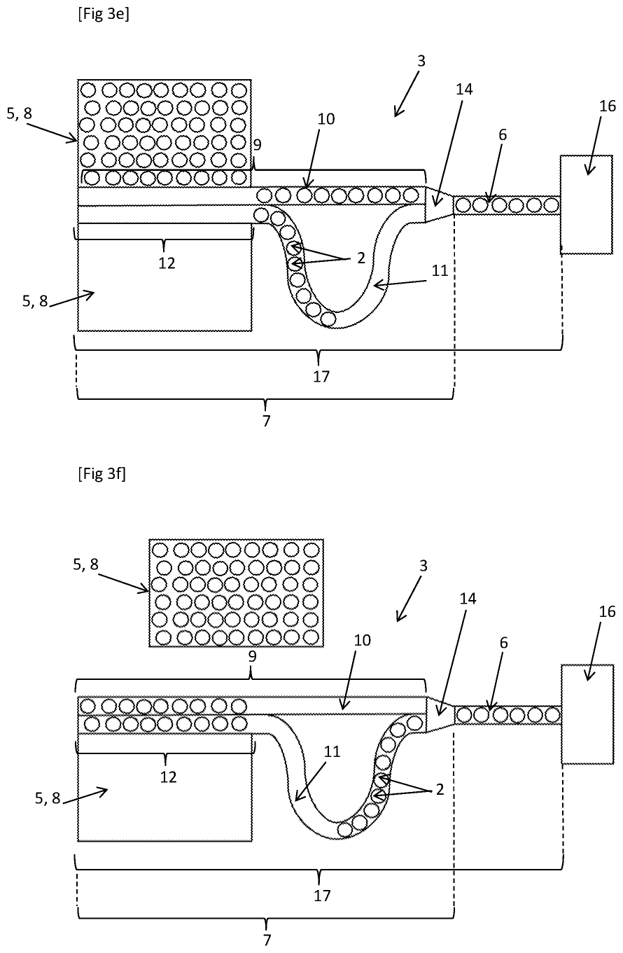

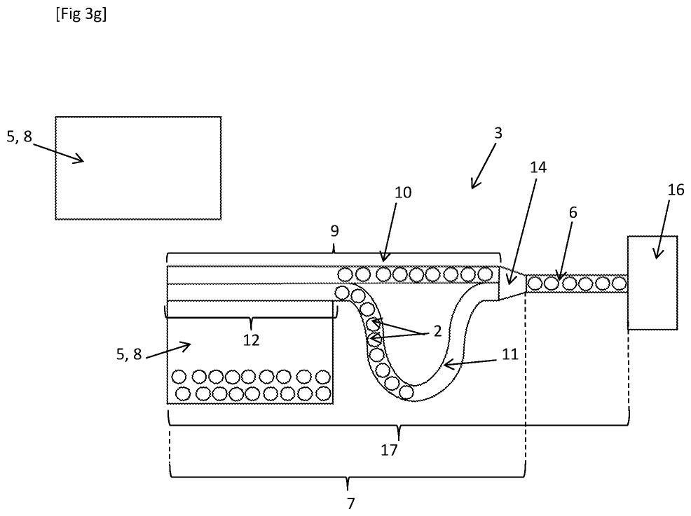

FIGS. 3a to 3g are schematic top views of the route of the products leaving an upstream station from the exit conveyor until successive transfer onto two receiving surfaces at different times,

FIG. 3b as mentioned above,

FIG. 3c as mentioned above,

FIG. 3d as mentioned above,

FIG. 3e as mentioned above,

FIG. 3f as mentioned above, and

FIG. 3g as mentioned above.

The invention therefore relates primarily to a continuous processing line 1 for products 2 comprising a plurality of successive processing stations 3, 4 for said products 2 and a plurality of autonomous self-supporting moveable trolleys 5 moving on the floor to transport the products 2 from an upstream station 3 to a downstream station 4, said upstream station 3 having an exit conveyor 6 at the exit thereof to feed the processed products 2 in a continuous single-lane flow.

The products 2 can be empty or full containers, notably bottles, cans, flasks, boxes, cases, cartons or bundles made of any type of material, notably glass or plastic, or cardboard. Such products 2 are usually intended to contain liquids or food.

The processing line 1 can be a complete installation providing full processing from manufacture of the product 2 to arrangement on pallets for subsequent tracking in a sorting center or shipment, or simply a portion of such an installation, notably for example a group of stations 3, 4 within such a complete shipment preparation installation.

In such an installation, the products 2 can first undergo a first unit finishing phase, for example by passing successively through blowing, filling and labeling stations. Once the units have been finished, the products can be grouped in batches to be packaged, for example in bundles or in boxes, using a bundling or boxing station respectively, after which the bundles or boxes can be stacked in successive layers on pallets at a palleting station.

Thus, the processing stations 3, 4 in particular transform individual products 2, for example for filling or labeling, or several container products 2 simultaneously to group said products in packs, or several box products 2 to arrange said products in layers on a pallet, inter alia. Successive stations 3, 4 can therefore manufacture, transform, store and/or change the geometric arrangement of the products 2. Naturally, the line 1 has stations 3, 4 that receive products 2 from the outside as the raw materials for the line 1, as well as stations 3, 4 that output the products 2 following processing by the line 1. The line 1 is therefore involved in the upstream preparation of units for logistical shipment, usually pallet based, but not the management, splitting or distribution of said units.

When designed for any function other than storage, the stations 3, 4 usually have an entry zone 15 where the products 2 are in principle routed continuously towards a processing zone 16. Once processed by a station 3, 4, the products 2 in principle continuously leave the processing zone 16 at an exit zone 17.

The line 1 is installed in an adapted hall or workshop, and the stations 3, 4 preferably rest on the floor. The means for moving the products 2 between stations 3, 4 conventionally used in the prior art are based on movable endless conveyor belts mounted on a static structure installed on the floor in the workshop. The operators of the line 1 move around this workshop and it is therefore notably necessary to provide walkways to move around said movement means. The stations 3, 4 are difficult to move and are usually anchored to the ground.

According to the invention, the products 2 to be processed by a station 3, referred to as the upstream station 3, are routed to the following station 4, referred to as the downstream station 4, where said products are again processed, using a fleet of self-supporting movable trolleys 5 that are able to move on the floor between the stations 3, 4 of the line 1. The trolleys 5 therefore link the different stations 3, 4 on the line 1 and ensure the flow of products 2 on the line 1.

The use of trolleys 5 thus optimizes flexibility as a function of the number of products 2 of a given format to be processed, and also as a function of the stations 3, 4 involved in created the given format, etc.

These trolleys 5 are autonomous shuttles or vehicles able to move several products 2 simultaneously between two successive stations. The movement of these trolleys 5 therefore moves the products 2 between the stations 3, 4. The trolleys 5 therefore move during production on the line 1. The trolleys 5 can have appropriate motors and power sources to ensure autonomy of movement.

The line 1 according to the invention is a continuous processing line 1 for products 2, i.e. a line that normally processes an uninterrupted flow of products. The stations 3, 4 therefore in principle receive the products 2 to be processed continuously and deliver the processed products 2 continuously. The trolleys 5 route the products 2 between the stations 3, 4 in groups.

The line 1 has a plurality of stations 3, 4, including at least one upstream station 3 and at least one downstream station 4. The at least one upstream station 3 has an exit conveyor 6 at the exit thereof to feed the products 2 continuously in a single-lane flow. Preferably, the at least one downstream station 4 has an entry conveyor at the entry thereof to continuously feed said station 4 with products 2 to be processed continuously in a single- or multi-lane flow.

The processing line 1 according to the invention is characterized in that said upstream station 3 also includes an exit transfer unit 7 arranged downstream of the exit conveyor 6 that is designed to absorb the continuous flow of products from the exit conveyor 6 and to transfer said products 2 in batches of one or more rows onto at least one receiving surface 8 that is the upper surface of at least one trolley 5.

The exit transfer unit 7 therefore guarantees continuous operation of the line 1. More specifically, this unit 7 can receive the uninterrupted flow of products 2 processed by an upstream station 3 and routed by the exit conveyor 6, and cut said flow into sections of several products 2 to be transferred simultaneously to a receiving surface 8. Each section is a section of the lane of products 2 coming out of the upstream station 3 and several rows can be placed side by side transversely to the movement thereof to be transferred simultaneously to a given receiving surface 8 by the exit transfer unit 7.

In principle, the exit zone 17 of an upstream station 3 is formed by the exit conveyor 6 and the exit transfer unit 7.

The exit transfer unit 7 according to the invention comprises at least:

transit conveyance means 9 comprising at least two single-lane transit conveyors 10, 11 of different lengths, said conveyors 10, 11 initially following different paths followed by parallel paths at least within a transfer zone 12 such that at least one trolley 5 can be positioned alongside each longitudinal edge of the transit conveyance means 9 and the products 2 on the entirety of the transit conveyors 10, 11 within the transfer zone 12 can be transferred simultaneously and transversely by least one transfer tool 13 onto a receiving surface 8 regardless of the longitudinal edge of the transit conveyance means 9 alongside which said surface is located;
diverting means 14 designed to direct the flow of products from the exit conveyor 6 alternately to one or other of the transit conveyors 10, 11.

The transfer unit 7 is in principle positioned at the downstream end of the exit conveyor 7. In particular, the diverting means 14 of the transfer units 7 are positioned directly at the end of the exit conveyor 6 to orient the products alternately to one or other of the transit conveyors 10, 11. Thus, the transit conveyance means 9 are positioned directly after the diverting means 14. These conveyance means 9 comprise several transit conveyors 10, 11 that extend in principle from the diverting means 14 at least as far as the transfer zone 12.

Preferably, the diverting means direct the continuous flow of products 2 alternately to the transit conveyors 10, 11 such as to successively transfer sections of several products one after the other onto each of the transit conveyors 10, 11. These sections are usually of substantially equal length and the same length as the batches of products 2 to be transferred to a receiving surface 8.

The transfer zone 12 is the location of the transfer unit 7 from which the batches of at least one row of products 2 are transferred to a receiving surface 8. Since the transfer is transversal, the products 2 are in principle stopped on the transit conveyors 10, 11 before being moved onto a receiving surface 8. The space occupied by this transfer zone 12 is then substantially the space occupied by the batches of products 2 to be transferred. In principle, the transfer zone 12 is substantially the same length as the dimension of the receiving surfaces 8 that can be alongside the transit conveyance means 9.

The at least one receiving surface 8 is the upper surface of one or more trolleys 5. Accordingly, this surface 8 can be the upper surface of a single trolley 5 or of several trolleys 5 arranged beside one another. Where the surface 8 is the upper surface of several trolleys 5, said trolleys can move independently of one another on the line 1.

Preferably, the upper surface of the trolleys 5 is rectangular. Preferably, the at least one receiving surface 8 is rectangular. Accordingly, said surface can in principle receive a group of products 8 formed by several rows of products 8 aligned in the direction of transfer of the products 2 from the transit conveyance means 9 onto the surface 8, in other words aligned transversally in relation to the longitudinal flow of the products on the transit conveyance means 9. Preferably, the length of the rows is substantially the same as the dimension of the receiving surface 8 alongside the transit conveyance means 9. The at least one receiving surface 8 is in principle flat and substantially horizontal, or horizontal.

Each transit conveyor 10, 11 can be formed by several conveyance modules motorized independently such as to enable one or more modules of a conveyor 10, 11 to be stopped while one or more other modules remain in operation.

In general, each transit conveyor 10, 11 forms a route for a single lane of products 2 coming from the exit conveyor 6, from the diverting means 14 to the transfer zone 14.

The single continuous lane of products 2 is therefore distributed between several transit conveyors 10, 11, each of which is preferably designed to transport a single lane of products 2.

Since these transit conveyors 10, 11 are of different lengths, said transit conveyors cannot follow the same path over the entire length thereof. Accordingly, said transit conveyors are separate over a first section of the transit conveyance means 9. The transit conveyors are then parallel and follow the same path, at least in the transfer zone 12. This enables the rows of products 2 that are in the transfer zone 12 to be transferred more easily and simultaneously to a receiving surface 8.

In the transfer zone 12, the transit conveyors 10, 11 are therefore side by side and preferably side by side longitudinally. The transit conveyors can be spaced apart, and a slider bed can be placed between each transit conveyor 10, 11.

The shortest transit conveyor 10 can be entirely straight or can include at least. one curve. The at least one other transit conveyor 11 has at least. one curve, on account of being longer than the transit conveyor 10.

The fact that the transit conveyors 10, 11 are of different lengths enables:

the products 2 carried by these different conveyors 10, 11 to reach the transfer zone 12 substantially simultaneously, while these conveyors 10, 11 are fed successively by the exit conveyor 6,
the transit conveyance means 9 to continue receiving the continuous flow of products 2 coming from the exit conveyor 6 when the transit conveyance means 9 are stopped in the transfer zone 12 to transfer a batch of products 2 therein. At this specific moment, the longest transit conveyors 10, 11 are in principle fed successively.

In principle, the transit conveyors 10, 11 are always fed in the same order, from the longest to the shortest, which advantageously enables the sections of each of the transit conveyors 10, 11 to be synchronized for transfer.

In general, a batch of products 2 comprises as many rows as there are transit conveyors 10, 11. The rows of a given batch are in principle arranged side by side within the transfer zone 12.

At least within the transfer zone 12, the transit conveyors 10, 11 are preferably straight such as to simplify the transfer of the batches, which are substantially rectangular when viewed from above on the receiving surface 8.

As indicated above, the transit conveyance means 9 are such that a receiving surface 8 can be positioned at both longitudinal edges thereof. There are therefore two locations that can host a receiving surface 8, which has the advantage of enabling transfer of the products 2 to continue even when one receiving surface 8 is full, or during movement towards a downstream processing station 4 before said surface has been replaced by another receiving surface 8.

This makes it possible to alternately feed a receiving surface 8 positioned alongside one of the longitudinal edges of the transit conveyance means 9 and a receiving surface 8 positioned alongside the other edge.

At the exit of the upstream station 3, whether this is on the exit conveyor 6 or the exit transfer unit 7, the products 2 are in principle resting on a substantially horizontal conveyance plane. The upper surfaces of the exit conveyors 6 and the transit conveyors 10, 11 are therefore preferably flat, horizontal and at the same height from the ground.

Preferably, during transfer of products 2 from the transfer zone 12 to a receiving surface 8, this receiving surface is arranged beside a longitudinal edge of the transfer zone 12 such that the receiving surface 8 and the upper surface of the transfer zone 12 are flush. This facilitates transfer, which can notably be carried out by transverse pushing.

The exit transfer unit 7 includes at least one transfer tool 13 that is designed to move the batches of one or more rows of products 2 from the transfer zone 2 to a receiving surface 8. Preferably, the exit transfer unit 7 comprises a single transfer tool 13 that is able to transfer the products 2 either to a receiving surface 8 positioned on one side of the transit conveyance means 9 or to a receiving surface 8 positioned on the other side of the transit conveyance means 9. Alternatively, a different transfer tool 13 can be used respectively to move the products 2 onto a receiving surface 8 positioned alongside both of the longitudinal edges of the transit conveyance means 9.

The at least one transfer tool 13 can be any type of tool able to move a batch of one or more rows of products 2. Accordingly, this tool can for example be a tool that grasps each product 2 individually, for example by the neck using grippers, and then lifts all of the products 2 in the batch and moves the batch to a receiving surface. However, the at least one transfer tool 13 is preferably a tool that transfers the products by pushing, notably by means of horizontal transverse sweeping. This type of tool is in fact more flexible in that the tool is compatible with a large range of formats of products 2 and does not require specific settings.

The line 1 can include a control center 18 that coordinates the movement of the trolleys 5 between stations 3, 4, at least by controlling the departure and arrival stations 3, 4 of each trolley 5, between which said trolley 5 is free to define a route, or also at least partially defining certain elements of said route.

The datum on the upstream station 3 from where the products 2 are collected and the datum on the downstream station 4 where the products 2 are subsequently delivered may be sufficient for the trolley 5, fitted with its own smart control unit, to define a path on the floor of the workshop housing the line 1. Preferably, the line 1 is provided with a control center 18 that communicates, notably wirelessly, with each of the trolleys 5 to send departure, destination and/or path instructions, inter alia, to coordinate the behavior of the fleet of trolleys 5 in general.

According to an additional possible feature, the difference in length between the at least two single-lane transit conveyors 10, 11 is substantially the length of the rows of products 2 transferred onto a receiving surface 8.

Accordingly, if the transit conveyors 10, 11 are classified from shortest to longest, the difference in length between two successive conveyors 10, 11 can be substantially the length of a row of products 2 to be transferred onto a receiving surface 8.

In particular, where there are exactly two transit conveyors 10, 11, the difference in length between these two conveyors can substantially be the length of the sections of products 2 that are sent alternately to the transit conveyor 10 and to the transit conveyor 11.

Ensuring that the length of the sections of products 2 to be transferred matches the difference in length between the transit conveyors 10, 11 advantageously helps to synchronize the arrival of the products 2 in the transfer zone 12 from each transit conveyor 10, 11.

Preferably, this difference in length between the transit conveyors 10, 11 is substantially the same as the longitudinal dimension of the receiving surface 8.

According to an additional possible feature, said transit conveyance means 9 comprise exactly two transit conveyors.

In this case, the batches of products 2 to be transferred are usually formed by two rows, one per transit conveyor 10, 11.

According to an additional possible feature, said transfer tool 13 is a pushing transfer means.

Such a tool 13 is designed to push a batch of products 2 by means of a transverse horizontal sweep. Preferably, the tool pushes the products 2 in a given batch in a direction perpendicular to the longitudinal direction inside the transfer zone, i.e. the direction in which each row to be transferred is oriented.

According to an additional possible feature, said exit transfer unit 7 comprises a single transfer tool 13 that is designed to transfer the products either to a receiving surface 8 arranged alongside a longitudinal edge of the transit conveyance means 9 or to a receiving surface 8 arranged alongside the other longitudinal edge of the transit conveyance means 9.

According to an additional possible feature, said transfer tool 13 includes longitudinal vertical pusher plates.

The number of plates in said transfer tool is preferably such that each row of products 2 in a batch to be transferred is positioned between two plates of said transfer tool 13.

The at least one transfer tool 13 can be a multi-axis robot. Said transfer tool can also be a cartesian robot. Thus, according to an additional possible feature, said transfer tool 13 is assembled movably along at least two axes, notably the horizontal and vertical axes. In particular, the transfer tool 13 can be assembled movably along a horizontal slide and along a vertical slide.

The at least one downstream station 4 of the processing line 1 for products 2 can have an entry transfer unit designed to enable the downstream station 4 to be fed continuously with products 2 while the products 2 are fed into the downstream station 4 in batches.

Thus, the at least one downstream station 4 can have an entry conveyor at the entry thereof that is designed to feed an uninterrupted flow of products 2 to the downstream station 4.

This entry conveyor can be a single-lane conveyor, i.e. designed to convey a single lane of products 2, in particular where the downstream station 4 is a station used to finish individual products 2, such as a labeler or a filling machine.

The entry conveyor of the at least one downstream station 4 can also be a multi-lane conveyor, i.e. designed to convey several lanes of products 2 side by side, in particular where the downstream station 4 is a packaging station, for example a bundler or a boxing machine.

Where the entry conveyor of the at least one downstream station 4 is a single-lane conveyor, the entry transfer unit can for example be similar to the exit transfer unit 7 described above, i.e. notably having several transit conveyors of different lengths.

Where the entry conveyor of the at least one downstream station 4 is a multi-lane conveyor, the entry transfer unit can be as described below. The transfer zone positioned between the potential locations of the receiving surfaces can be made up of conveyance means comprising at least two independently motorized conveyance surfaces, each of which occupies the entire width of the transfer zone, with both extending alongside the conveyance means.

Consequently, where a first conveyance surface is stopped at a given instant in the transfer zone, at least one other surface previously loaded with products 2 can be moved towards the entry conveyor of the downstream machine 4 to feed said conveyor. Once the products 2 have been loaded onto the first surface, said surface can be moved, preferably with sufficient acceleration to catch the second surface, until contact is made and the two surfaces are made continuous. The second surface returns empty to the transfer zone. The cycle can then be repeated reciprocally when the second surface is stopped.

Thus, when positioned in the transfer zone, just one of the surfaces receives products 2 at a given time in order to convey said products to the entry conveyor.

The invention also relates to a method for transporting products from an upstream station 3 to a downstream station 4 on a processing line 1 for products 2, as defined above.

This method involves transferring the products 2 in batches of one or more rows from the exit conveyor 6 of the upstream station to a receiving surface 8, then moving said products 2 to the downstream station 4 using the movement of the at least one trolley 5, the upper surface of which is the receiving surface 8.

This method is characterized in that the transfer of a batch of products 2 involves at least the following steps:

(i) directing the continuous flow of products from the exit conveyor 6 alternately to each of the transit conveyors 10, 11, starting with the longest transit conveyor before switching from the longest transit conveyor to the shortest transit conveyor;
(ii) stopping all of the transit conveyors 10, 11 in the transfer zone 12 when said zone is filled with products 2, while continuing to feed the transit conveyors 10, 11 according to step (i);
(iii) simultaneously transferring all of the products 2 in the transfer zone 12 onto a receiving surface 8 arranged alongside one or other of the longitudinal edges of the transit conveyance means 9, while continuing to feed the transit conveyors 10, 11 according to step (i).

Thus, during step (i), the transit conveyors 10, 11 are fed by the exit conveyor 6 in decreasing order of length, the longest transit conveyor 11 therefore being fed first, while the shortest transit conveyor 10 is fed last. The feed cycle of the transit conveyors 10, 11 is therefore repeated continuously in this order so as to continue to absorb the continuous flow of products 2 when the transit conveyors 10, 11 are stopped in the exit transfer zone 7 during transfer of a batch to a receiving surface 8. In other words, this enables execution of step (ii) of the method according to the invention.

On completion of step (ii), the exit transfer zone 7 is stopped and is carrying a batch of products 2 to be transferred to a receiving surface 8, said surface 8 being positioned alongside the transfer zone 7 on one side or other in relation to the transit conveyors 10, 11. The batch of products 2 in principle comprises several rows of products 2, one per transit conveyor 10, 11. Preferably, such a batch is formed by two rows of products 2, or two sections of products 2, usually of similar length, sent successively from the exit conveyor 6.

During step (iii), the batch of products 2 is moved onto a receiving surface 8 by a transfer tool 12 as described above.

Throughout the method, the products 2 are delivered by the exit conveyor 6 and directed in sections, which are in principle of similar length, alternately onto the transit conveyors 10, 11.

The products 2 are transferred onto a receiving surface in a direction transverse to the arrival of the products 2 into the transfer zone 12, preferably in an orthogonal direction.

According to an additional possible feature, several batches of products 2 are transferred successively onto a given receiving surface 8 before being moved to said downstream station.

Indeed, a given receiving surface can receive several batches of products 2 side by side in the transverse direction.

Preferably, a receiving surface 8 is filled before moving the at least one trolley 5, the upper surface of which is the receiving surface 8, to the downstream station 4. In other words, as many products 2 as possible are placed on the receiving surface 8 before sending the products 2 carried by the receiving surface to the following machine, which helps to achieve the desired line throughput with a minimum of trolleys 5, thereby helping to limit costs. A receiving surface 8 is full when said surface contains a group of products 2, usually formed by several batches 2 of products. The groups and batches of products are substantially rectangular when viewed from above.

Several batches of products 2 can therefore be transferred successively onto a given receiving surface 8 until said surface is full, i.e. until said surface can no longer receive another batch, before starting to feed a new receiving surface 8 with batches of products. In principle, this new receiving surface 8 is positioned on the other side of the transfer zone 12 opposite the location of the first receiving surface 8 during filling thereof.

Thus, once a receiving surface 8 arranged on one side of the transfer zone 12 has been filled, said surface can be moved to the downstream station 4. During this time, a new receiving surface 8 arranged on the other side of the transfer zone 12 receives the batches of products 2, and a further receiving surface 8, which is notably empty or partially full, is moved to the location where the first receiving surface 8 received the products 2 from the transfer zone 12, and so forth.

Thus, according to an additional possible feature, once a receiving surface 8 arranged at one of the longitudinal edges of the transit conveyance means 9 has been filled with products 2, the products 2 of the transit conveyance means 9 are then transferred to a receiving surface 8 arranged at the other longitudinal edge of the transit conveyance means 9.

Different possible layouts are shown in the embodiment illustrated in the attached figures.

In particular, FIG. 1 shows a possible layout of the processing line 1 according to the invention. The line shown has three processing stations 3, 4, each of which has:

an entry zone 15 where the station 3, 4 is fed with a continuous flow of products 2,
a processing zone 16 where the products 2 undergo a process specific to the station 3, 4 (such as filling or boxing), and
an exit zone 17 from which the products 2 processed by the station 3, 4 are fed continuously.

The trolleys 5 can move between the different stations 3, 4 to carry the products from an upstream station 3 to a downstream station 4.

These trolleys can also be positioned at the entry 15 or the exit 17 of a station 3, 4 in order to supply a station 3, 4 with products 2 to be processed or to receive the products 2 processed by a station 3, 4 in order to move said products to the following station 3, 4.

In FIG. 1, the receiving surfaces 8 at the stations 3, 4 are the upper surface of a single trolley 5.

The line 1 shown in FIG. 1 also has a control center 18 designed to control operation of the line 1, i.e. notably to control the movement of the trolleys 8.

FIG. 2 is a detailed perspective view of the processing zone 16 and the exit zone 17 of an upstream station 3. In this figure, the exit transfer unit 7 has transit conveyance means 9 formed by two single-lane transit conveyors 10, 11. Each of the two transit conveyors 10, 11 has at least one curved portion intended to optimize installation of the stations 3, 4 in the line 1. In practice, each of the conveyors 10, 11 shown in FIG. 2 has two curved portions.

The shorter transit conveyor 10 is therefore the inside conveyor and the longer transit conveyor 11 is the outside conveyor. These two transit conveyors 10, 11 are initially side by side and relatively close to one another, potentially in contact, and follow a straight path. The shorter conveyor 10 then enters the first curved portion to perform a 90° turn, while the longer conveyor 11 continues on a linear path. The two conveyors 10, 11 then move away from one another and follow different paths. The conveyor 11 enters the first curved portion later, also performing a 90° turn. The two conveyors 10, 11 then have a straight path and are again parallel with one another, but relatively further away from one another such that there is a sufficiently wide gap between these two conveyors 10, 11. The two conveyors 10, 11 then enter the second curved portion to perform another 90° turn. The two conveyors 10, 11 move towards one another again and describe straight flows parallel to the paths thereof that precede the first curved portions. In the transfer zone 12, the two single-lane conveyors 10, 11 are then side by side, are close to one another and follow a straight path.

FIG. 2 shows a layout in which a single transfer tool 13 is used to transfer batches of products 2 on either side of the transfer zone 12, in a transverse direction possibly orthogonal to the arrival direction of the products 2 in the transfer zone 12.

More specifically, the transfer tool 13 shown is a pushing transfer tool 13 provided with three vertical longitudinal plates.

In the layout shown, the batches of products 2 in principle comprise two rows side by side, and each row can be positioned between two plates of the tool 13 for transfer.

In FIG. 2, each of the two receiving surfaces 8 is formed by two autonomous trolleys arranged side by side. The trolley 5 in the bottom left appears to be moving, while the other three trolleys 5 are positioned to receive products 2.

FIG. 3 shows another possible layout of the processing zone 16 and of the exit zone 17 of an upstream station 3 with two transit conveyors 10, 11, seen from above and at different instants of flow of the products 2 (see FIGS. 3a, 3b, 3c, 3d, 3e, 3f and 3g).

FIG. 3 shows the route of the products coming out of an upstream station 3 with an exit zone 17 as follows: the products 2 leave the processing zone 16 of the upstream station 3 via a single-lane exit conveyor 6 that leads to diverting means 14 designed to direct the products 2 alternately to one or other of the transit conveyors 10, 11 of the exit transfer unit 7.

In the layout shown in FIG. 3, the shorter transit converter 10 follows a straight path, while the longer transit conveyor follows a path including a curved portion. The two conveyors 10, 11 are side by side in the transfer zone 12 and the receiving surfaces 8 shown here are the upper surface of a single trolley 5. For the sake of clarity, the at least one transfer tool 13 is not shown in this figure.

The route of the products as shown in FIGS. 3a, 3b, 3c, 3d, 3e, 3f and 3g is described below.

In FIG. 3a, the diverting means 14 direct the uninterrupted flow of products 2 from the exit conveyor 6 to the longer transit conveyor 11, while the shorter transit conveyor 10 is carrying no products 2.

In FIG. 3b, the diverting means 14 direct the uninterrupted flow of products 2 from the exit conveyor 6 to the transit conveyor 10, while the section of products 2 previously sent to the conveyor 11 continues the route towards the transfer zone 12. The two sections of products 2 sent respectively to the transit conveyors 10, 11 are of substantially the same length. Furthermore, the difference in length between the transit conveyors 10 and 11 is substantially the length of one section, so that the products 2 on each of the conveyors 10 and 11 reach the start of the transfer zone 12 at substantially the same time.

In FIG. 3c, the first two sections of products 2 mentioned above are both in the transfer zone 12 forming a batch of products 2, and the transit conveyors 10, 11 are stopped in said zone 12 for transverse or orthogonal transfer to a receiving surface 8. During this time, the diverting means 14 again direct the uninterrupted flow of products 2 from the exit conveyor 6 to the longer transit conveyor 11.

FIG. 3d shows the situation following transfer of the batch of products 2 to the receiving surface 8 shown at the top of the figure. On completion of this transfer, the transit conveyors 10, 11 revert to the same layout as shown in FIG. 3b, specifically with two new sections of products 2 that arrive at the entry of the transfer zone 12 substantially simultaneously to form a new batch of products 2 to be transferred.

This succession of steps is reproduced continuously. Thus, FIG. 3a shows the layout once three batches of two sections of products 2 each have been transferred onto the same receiving surface 8 (the surface shown at the top of the figure). The surface 8 is then full and contains six rows of products 2. In FIG. 3f, the trolley 5 carrying the full receiving surface 8 is moving towards the downstream station, while a new batch of products 2 is ready to be transferred to the receiving surface shown at the bottom of the figure. Finally, FIG. 3g no longer shows the full trolley 5, but a new trolley 5 arriving to be positioned alongside the top edge of the transfer zone 12 to replace the receiving surface 8 previously filled with products 2, while a batch of products 2 has already been transferred onto the receiving surface 8 at the bottom and a new batch is arriving in the transfer zone 12.

The invention provides, upstream of a logistics shipping center for finished assemblies, a processing line 1 for products 2 that is highly versatile and flexible, in which the processing stations 3, 4 can be modified very easily, without having to redesign or refit any static conveyors or corresponding infrastructure: electrical power supply for associated motors, passageways, etc. Furthermore, the arrangement of the exit transfer unit 7 as described, and notably the presence of several transit conveyors 10, 11 of different lengths, advantageously enables the products 2 processed by an upstream machine 3 continuously feeding the products 2 to be loaded onto the trolleys 5 in batches (one batch being formed by one or more rows arranged side by side), once these products have been stopped for transfer. Where there is also an entry transfer unit as described above at the entrance of an upstream station 4, the trolleys 5 containing the products 2 to be processed by the station 4 can also be unloaded in batches or rows onto this entry transfer unit, subsequently enabling the downstream station 4 to be fed continuously.

Although the description above is based on specific embodiments, this in no way limits the scope of the invention, and modifications may be made, notably by means of technically equivalent substitutes or different combinations of all or some of the features discussed above.

1. A continuous processing line (1) for products (2) comprising a plurality of successive processing stations (3, 4) for said products (2) and a plurality of autonomous self-supporting movable trolleys (5) moving on the floor to transport the products (2) from an upstream station (3) to a downstream station (4); said upstream station (3) having an exit conveyor (6) at the exit thereof to feed the processed products (2) in a continuous single-lane flow;
wherein said upstream station (3) also includes an exit transfer unit (7) arranged downstream of the exit conveyor (6) that is designed to absorb the continuous flow of products (2) from the exit conveyor (6) and to transfer said products (2) in batches of one or more rows onto at least one receiving surface (8) that is the upper surface of at least one trolley (5); said transfer unit (7) including at least:
transit conveyor (9) comprising at least two single-lane transit conveyors (10, 11) of different lengths, said conveyors (10, 11) initially following different paths followed by parallel paths at least within a transfer zone (12) such that at least one trolley (5) can be positioned alongside each longitudinal edge of the transit conveyor (9) and the products (2) on the entirety of the transit conveyors (10, 11) within the transfer zone (12) can be transferred simultaneously and transversely by least one transfer tool (13) onto a receiving surface (8) regardless of the longitudinal edge of the transit conveyor (9) alongside which said surface is located; and
diverter (14) designed to direct the flow of products from the exit conveyor (6) alternately to one or other of the transit conveyors (10, 11).

2. The processing line (1) as claimed in claim 1, wherein the difference in length between the at least two single-lane transit conveyors (10, 11) is substantially the length of the rows of products (2) transferred onto a receiving surface (8).

3. The processing line (1) as claimed in claim 1, wherein said transit conveyance means conveyor (9) comprise exactly two transit conveyors (10, 11).

4. The processing line (1) as claimed in claim 1, wherein said transfer tool (13) is a pushing transfer means.

5. The processing line (1) as claimed in claim 1, wherein said exit transfer unit (7) comprises a single transfer tool (13) that is designed to transfer the products (2) either to a receiving surface (8) arranged alongside a longitudinal edge of the transit conveyor (9) or to a receiving surface (8) arranged alongside the other longitudinal edge of the transit conveyor (9).

6. The processing line (1) as claimed in claim 1, wherein said transfer tool (13) includes longitudinal vertical pusher plates, and the number of plates in said transfer tool (13) is preferably such that each row of products (2) in a batch to be transferred is positioned between two plates of said transfer tool (13).

7. The processing line (1) as claimed in claim 1, wherein said transfer tool (13) is assembled movably along at least two axes, notably the horizontal and vertical axes.

8. A method for transporting products (2) from an upstream station (3) to a downstream station (4) on a processing line (1) for products (2) as defined in claim 1, that involves transferring the products (2) in batches of one or more rows from the exit conveyor (6) of the upstream station (3) to a receiving surface (8), then moving said products (2) to the downstream station (4) using the movement of the at least one trolley (5), the upper surface of which is the receiving surface (8), wherein the transfer of a batch of products (2) involves at least the following steps:
(i) directing the continuous flow of products (2) from the exit conveyor alternately to each of the transit conveyors (10, 11), starting with the longest transit conveyor (10, 11) before switching from the longest transit conveyor to the shortest transit conveyor;
(ii) stopping all of the transit conveyors (10, 11) in the transfer zone (12) when said zone is filled with products (2), while continuing to feed the transit conveyors (10, 11) according to step (i); and
(iii) simultaneously transferring all of the products (2) in the transfer zone (12) onto a receiving surface (8) arranged alongside one or other of the longitudinal edges of the transit conveyor (9), while continuing to feed the transit conveyors (10, 11) according to step (i).

9. Transport method as claimed in claim 8, wherein several batches of products (2) are transferred successively onto a given receiving surface (8) before being moved to said downstream station (4).

10. Transport method as claimed in claim 8, wherein, once a receiving surface (8) arranged at one of the longitudinal edges of the transit conveyor (9) has been filled with products, the products (2) of the transit conveyor (9) are then transferred to a receiving surface (8) arranged at the other longitudinal edge of the transit conveyor (9).

11. The processing line (1) as claimed in claim 1, wherein said transit conveyor (9) comprise exactly two transit conveyors (10, 11).

12. The processing line (1) as claimed in claim 2, wherein said transfer tool (13) is a pushing transfer means.

13. The processing line (1) as claimed in claim 3, wherein said transfer tool (13) is a pushing transfer means.

14. The processing line (1) as claimed in claim 2, wherein said exit transfer unit (7) comprises a single transfer tool (13) that is designed to transfer the products (2) either to a receiving surface (8) arranged alongside a longitudinal edge of the transit conveyor (9) or to a receiving surface (8) arranged alongside the other longitudinal edge of the transit conveyor (9).

15. The processing line (1) as claimed in claim 3, wherein said exit transfer unit (7) comprises a single transfer tool (13) that is designed to transfer the products (2) either to a receiving surface (8) arranged alongside a longitudinal edge of the transit conveyor (9) or to a receiving surface (8) arranged alongside the other longitudinal edge of the transit conveyor (9).

16. The processing line (1) as claimed in claim 2, wherein said transfer tool (13) includes longitudinal vertical pusher plates, and the number of plates in said transfer tool (13) is preferably such that each row of products (2) in a batch to be transferred is positioned between two plates of said transfer tool (13).

17. The processing line (1) as claimed in claim 3, wherein said transfer tool (13) includes longitudinal vertical pusher plates, and the number of plates in said transfer tool (13) is preferably such that each row of products (2) in a batch to be transferred is positioned between two plates of said transfer tool (13).

18. The processing line (1) as claimed in claim 2, wherein said transfer tool (13) is assembled movably along at least two axes, notably the horizontal and vertical axes.

19. The processing line (1) as claimed in claim 3, wherein said transfer tool (13) is assembled movably along at least two axes, notably the horizontal and vertical axes.

20. Transport method as claimed in claim 9, wherein, once a receiving surface (8) arranged at one of the longitudinal edges of the transit conveyor (9) has been filled with products, the products (2) of the transit conveyor (9) are then transferred to a receiving surface (8) arranged at the other longitudinal edge of the transit conveyor (9).
